(19) United States
(12) Patent Application Publication
(10) Pub. No.: US 2013/0313995 A1
(43) Pub. Date: Nov. 28, 2013

(54) Dimmable LED Driver

(71) Applicant: Laurence P. Sadwick, Salt Lake City, UT (US)

(72) Inventor: Laurence P. Sadwick, Salt Lake City, UT (US)

(21) Appl. No.: 13/903,349

(22) Filed: May 28, 2013

Related U.S. Application Data
(60) Provisional application No. 61/652,033, filed on May 25, 2012.

(51) Int. Cl. H05B 37/02

(52) U.S. Cl. CPC H05B 37/02
USPC 315/287; 315/307; 315/309

(57) ABSTRACT

A dimmable driver comprising a dimming control signal.

### BACKGROUND

Electricity is generated and distributed in alternating current (AC) form, wherein the voltage varies sinusoidally between a positive and a negative value.

However, many electrical devices require a direct current (DC) supply of electricity having a constant voltage level, or at least a supply that remains positive even if the level is allowed to vary to some extent. For example, light emitting diodes (LEDs) and similar devices such as organic light emitting diodes (OLEDs) are being increasingly considered for use as light sources in residential, commercial and municipal applications. However, in general, unlike incandescent light sources, LEDs and OLEDs cannot be powered directly from an AC power supply unless, for example, the LEDs are configured in some back to back formation. Electrical current flows through an individual LED easily in only one direction, and if a negative voltage which exceeds the reverse breakdown voltage of the LED is applied, the LED can be damaged or destroyed. Furthermore, the standard, nominal residential voltage level is typically something like 120 V or 240 V, both of which are often higher than may be desired for a high efficiency LED light. Some conversion of the available power may therefore be necessary or highly desired with loads such as an LED light.

### SUMMARY

A dimmable LED driver is disclosed that enables controlling current to a load. In some embodiments, this comprises processing a 0 to 10 V Dimming signal to set the minimum and/or maximum load current. In some embodiments, this comprises controlling load current based on temperature, input voltage level, or other conditions. The embodiments shown and disclosed herein are intended to be examples of the present invention and in no way or form should these examples be viewed as being limiting of and for the present invention.

This summary provides only a general outline of some particular embodiments. Many other objects, features, advantages and other embodiments will become more fully apparent from the following detailed description.

### BRIEF DESCRIPTION OF THE DRAWINGS

A further understanding of the various embodiments may be realized by reference to the figures which are described in remaining portions of the specification. In the figures, like reference numerals may be used throughout several drawings to refer to similar components.

FIG. 1 depicts a block diagram of a dimmable LED controller in accordance with some embodiments of the invention;

FIG. 2 depicts a schematic of a dimming controller in accordance with some embodiments of the invention;

FIGS. 3 and 4 depict input versus output voltage plots during operation of one embodiment of the dimming controller of FIG. 2 in accordance with some embodiments of the invention;

FIG. 5 depicts a schematic of a thermal controller for an dimmable driver in accordance with some embodiments of the invention;

FIG. 6 depicts a schematic of a dimming controller in accordance with some embodiments of the invention;

FIG. 7 depicts a diagram of a dimmable LED driver in accordance with some embodiments of the invention;

FIG. 8 depicts a diagram of another dimmable LED driver in accordance with some embodiments of the invention;

FIG. 9 depicts a block diagram of a dimmable LED driver in accordance with some embodiments of the invention; and

FIG. 10 depicts a flow chart of an operation for regulating a load current.

### DESCRIPTION

A dimmable LED driver is disclosed herein that can be used to provide power for lights such as LEDs of any type, including organic LEDs (OLEDs), as well as other loads, including but not limited to, fluorescent lamps (FLs) including, and also not limited to, compact fluorescent lamps (CFLs), energy efficient FLs, cold cathode FLs (CCFLs), etc. The inventions disclosed herein are not limited to the example circuits and applications illustrated, and may be adapted to, for example but not limited to, the circuits and applications disclosed in U.S. Patent Application 61/646,289 filed May 12, 2012 for a “Current Limiting LED Driver”, which is incorporated herein by reference for all purposes.

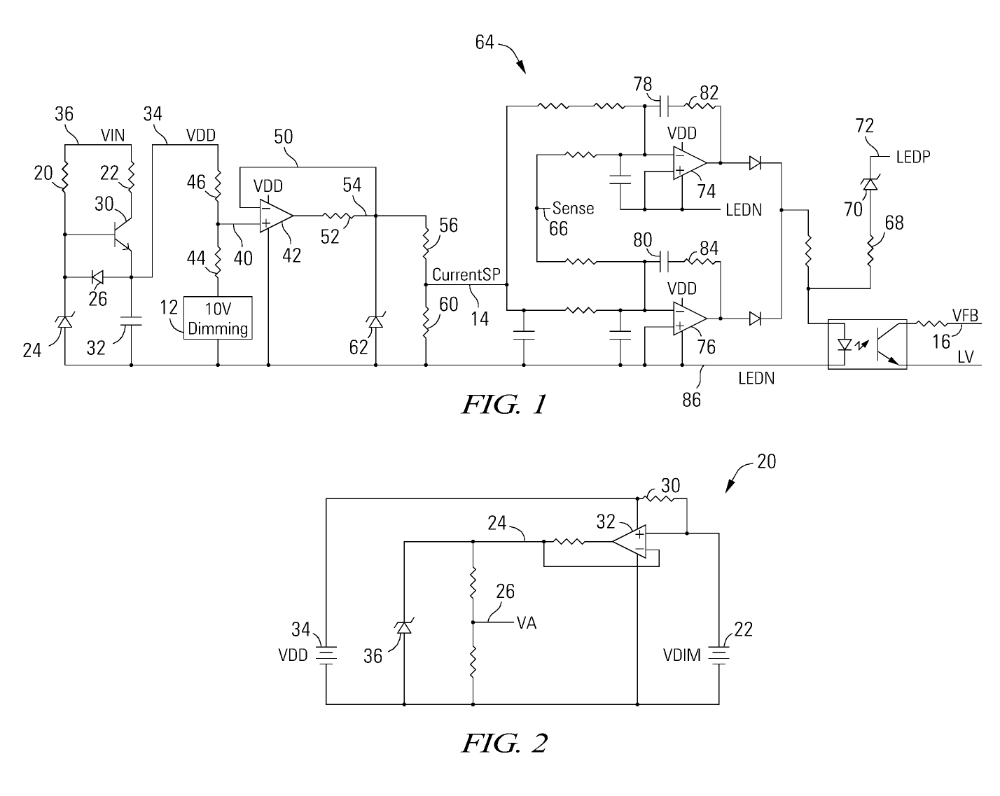

An example embodiment of a dimmable LED controller 10 is illustrated in FIG. 1, in which, for example, a 0 to 10 V Dimming input 12 can be used to control the reference voltage level at a CurrentSP node 14 to set the minimum to maximum load current, respectively. Any type of dimmer, signal, source, etc. may be used to provide a variable 0-10 V signal at the 10 V Dimming input 12. The LED driver 10 may be adapted to other dimming control signals, other voltage levels (e.g., 0 to 2 V, 0 to 5 V, −5 to 5 V, −15 to 15 V, etc.), and other locations or methods of dimming control in the LED driver, including, but not limited to phase angle/cut and other analog, digital and mixed signal signals including, for example digital parallel or series signals, circuits, interfaces, etc. such as RS232, RS485, I2C, SPI, and other wired, powerline, wireless communications, signals, etc. In the examples disclosed herein, if the 0 to 10 V Dimming input 12 is not connected to a dimming source, the LED driver 10 is operable to output the maximum load current without dimming. However such examples are not meant to be limiting and the present invention can be also be implemented in various other ways and variations including ones that produce zero output or some reduced output to the load when no external dimming source is connected.

The dimmable LED driver 10 may also provide overcurrent control, overtemperature control, overvoltage control, external signal/stimulus control, etc. reducing, for example, a control voltage VFB 16 to, for example, reduce the pulse width from a pulse generator used to control power into the LED Driver and the load.

Power may be provided for internal components of the dimmable LED driver 10 using, for example, a circuit including resistor 20, resistor 22, Zener diode 24, diode 26, transistor 30 and capacitor 32 that derives a voltage VDD 34 from another source VIN 36. For example, the source 36 may be, but is not limited to, a DC voltage derived from a rectified AC line voltage, such as an AC line voltage between about 100 to 120 VAC or about 200 to 240 VAC. Based on the voltage rating of the Zener diode 24 and other components, the resulting voltage VDD 34 may be, but is not limited to, about 15 VDC.

A 0 to 10 V Dimming input 12 may be connected to any suitable dimming source, providing an input voltage VDIM 40 at the non-inverting input of op-amp 42. Op amp 42 may or may not be part of an integrated circuit (IC), application specific IC (ASIC), a stand-alone IC, or other form of integration. (Resistor 44 is an optional resistor that may have, for example, a relatively very small resistance or that may be omitted.) Thus, with the 0 to 10 V Dimming input 12 connected to a dimmer source, the voltage VDIM 40 at the non-inverting input of op-amp 42 will be set by the dimmer source. If no dimmer is connected to the 0 to 10 V Dimming input 12, resistor 46 acts as a pullup resistor that pulls the non-inverting input of op-amp 42 up to the VDD supply rail 34.

feedback loop 50 connects the inverting input of op-amp 42 to the output of op-amp 42 through resistor 52. With resistor 52 in place, the output voltage VOut 54 at the right side of resistor 52 is equal to the voltage at the non-inverting input of the op-amp 42, which is set by the voltage VDIM 40 and thus by the 0 to 10 V Dimming input 12, if connected, or at the supply rail voltage 34 via pullup resistor 46. The op-amp 42 forces the voltage at the inverting input to equal that at the non-inverting input, so any voltage drop that occurs due to current flowing through resistor 52 is accounted for.

Resistor 56 and resistor 60 form a voltage divider, forming a reference voltage at the CurrentSP node 14. Zener diode 62 limits the voltage at the input 54 of voltage divider 56, 60 to 10 V (or to another voltage level depending, for the example implementation of the present invention under discussion, on the Zener diode selected). If the 0 to 10 V Dimming input 12 is connected to a dimmer source and the voltage VDIM at the 0 to 10 V Dimming input 40 drops below 10 V, the voltage at the input of voltage divider 56, 60 will drop accordingly.

The voltage divider 56, 60 generates a reference voltage at the CurrentSP node 14 to set the maximum load current. If the LED driver 10 is dimmed by lowering the voltage from the 0 to 10 V Dimming input 40, the reference voltage the CurrentSP node 14 will be reduced accordingly. The CurrentSP node 14 may be used to set the maximum load current for a feedback circuit 64 for any suitable driver circuit, such as, but not limited to those disclosed in U.S. patent application Ser. No. 13/299,912 filed Nov. 18, 2011 for a “Dimmable Timer-Based LED Power Supply”, which is incorporated herein by reference in its entirety for all purposes.

Feedback circuit 64 may be used in a driver circuit to control transients as well as current through a load using, for example, multiple time constants. Notably, the dimmable LED driver 10 with the 0-10V Dimming control is not limited to use with the feedback circuit 64 with multiple time constants.

The feedback circuit 64 can be used to produce the control signal VFB 16 to a timer-based variable pulse generator or other driver circuit control mechanism, based on the load current feedback signal 66. The feedback circuit 64 produces control signal VFB 16 based on the load current feedback signal 66 using, in the example shown, at least two time constants, to enable the feedback circuit 64 to clamp down on transient spikes, overshoot, etc. in the current through the load as well as to provide normal operating control of the current through the load.

Overvoltage protection may be included using a resistor 68 and one or more Zener diodes 70, for example when using a dimmable power supply with a transformer connected, for example but not limited to, buck, boost, buck-boost, boost-buck, forward-converter, flyback, etc. modes. As an example, a flyback feedback signal 72 is connected to the control signal VFB 16 through the resistor 68 and Zener diode 70, and if the flyback feedback signal 72 reaches the breakdown voltage of the Zener diode 70, the control signal VFB 16 will be pulled up to dim or turn off the LED driver. In some embodiments, the control signal VFB 16 causes a pulse controlled LED driver to dim or turn off by shortening or turning off the pulses from a variable pulse generator.

In the feedback circuit 64, the load current feedback signal 66 and the CurrentSP node 14 are compared in two or more op-amps 74 and 76, each with a different time constant. In one embodiment illustrated in FIG. 1, the different time constants are produced using different values of capacitors 78 and 80 and/or resistors 78 and 80 in the op-amp feedback paths. As the feedback signals with different time constants are combined in the control signal VFB 16, the control signal VFB 16 reacts to both fast and slow changes in the current through the load. In other embodiments, more, less or no time constants are used.

In other embodiments, signal 72 may be used to drive a load from VDD by connecting signal 72 to to the anode of an LED lamp. In some other embodiments configured as a buck converter, signal 72 may be driven from source VIN 36, such as, but not limited to, a rectified AC signal, and LEDN 86 is a floating ground. In yet other embodiments configured as a flyback, signal 72 is on a secondary side and not directly connected to source VIN 36. The dimming LED driver may be configured in continuous conduction mode (CCM), critical conduction mode (CRM), discontinuous conduction mode (DCM), resonant conduction modes, etc., with any type of circuit topology including but not limited to buck, boost, buck-boost, boost-buck, cuk, SEPIC, flyback, forward-converters, etc. The present invention works with both isolated and non-isolated designs including, but not limited to, buck, boost-buck, buck-boost, boost, flyback and forward-converters. The present invention itself may also be non-isolated or isolated, for example using a tagalong inductor or transformer winding or other isolating technique.

The present invention supports all standards and conventions for 0 to 10 V dimming or other dimming techniques, including, but not limited to, transformers including signal, gate, isolation, etc. transformers, optoisolators, optocouplers, etc. The present invention can also support all standards, methods, techniques, etc. for interfacing, interacting with and supporting 0 to 10 V dimming.

An embodiment of a dimming controller 20 is illustrated in FIG. 2, in which a VDIM voltage supply 22 represents a voltage from a dimmer from, for example but not limited to, a 0-10 V Dimmer. When VDIM is connected, VOUT 24 will track VDIM 22, and output VA 26 will be a divided version of VOUT 24. If VDIM 22 is not connected, resistor 30 will pull the non-inverting input of op-amp 32 up to or close to VDD 34, op-amp 32 will supply current in an attempt to pull VOUT 24 up to the rail 34, and VOUT 24 will stay at the voltage limited by Zener diode 36, setting a maximum constant voltage level at output VA 26 to limit the load current.

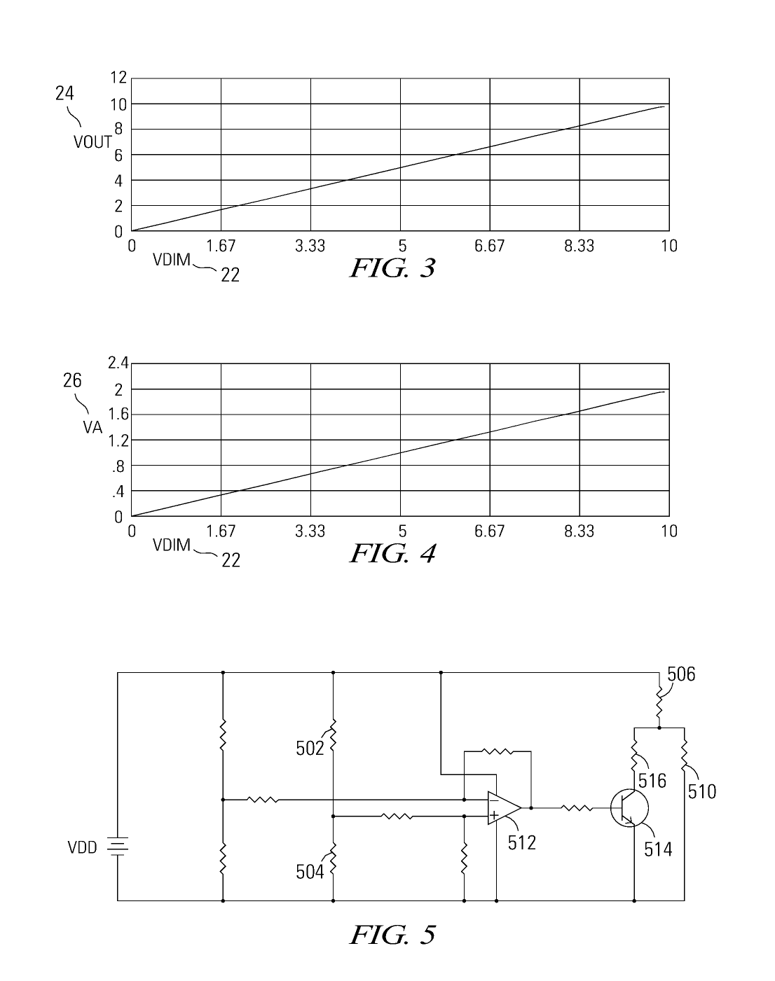

FIG. 3 depicts a graph of VOUT 24 vs the input voltage set by VDIM 22 in accordance with some embodiments of the invention. Again, in some embodiments VDIM 22 is provided by a 0 to 10 V Dimmer. In other embodiments, VDIM 22 is provided by other dimming devices, sources, or interfaces, whether wired or wireless, and from any input device, control interface, programmed source, or other circuit or device. FIG. 4 depicts a graph of VA 26 vs VDIM 22 in the circuit of FIG. 2 in accordance with some embodiments of the invention. However, the dimmable LED driver is not limited to circuits receiving or yielding these particular voltages.

Turning to FIG. 5, an embodiment of a thermal controller 500 for an LED dimming driver is depicted. In this embodiment, one or more thermistors provide temperature-based load current limiting. For example, either of resistors 502 or 504 may comprise thermistors. The circuit of FIG. 5 may be applied in any dimming driver to provide thermal control. As a non-limiting example, the circuit of FIG. 5 may be included in the dimming driver of FIG. 1, with resistors 506 and 510 of FIG. 5 corresponding with resistors 56 and 60 of FIG. 1.

When the temperature rises, the non-inverting input of op-amp 512 rises above the inverting input, the op-amp 512 turns on, turning on bipolar transistor 514, and connecting resistor 516 in parallel with resistor 510, the lower leg of voltage divider 56, 60 of FIG. 1. The reference voltage at CurrentSP 14 in FIG. 1 is divided by a ratio based on the resistor values selected for 56, 60, and 516. If 516 and 60 are roughly equal, the resistance in the lower leg of the divider will be halved, and the reference voltage at CurrentSP 14 will drop by a factor of two. The output power, no matter where the circuit is in the dimming cycle, will also drop by a factor of two. Values other than a factor of two (i.e., 500) can also be used and are easily implemented in the present invention by, for example, changing components of the example circuits described here for the present invention. As an example, a resistor change for resistor 516 in FIG. 5 and/or resistor 60 in FIG. 1, respectively, would allow and result in a different power decrease than a factor of two. The present invention can be made to have a more digital-like decrease in output power or a more gradual analog-like decrease, including, for example, a linear decrease in output power once, for example, the temperature or other stimulus/signal(s) trigger/activate this thermal or other signal control. In other embodiments, the present invention may also be used to turn off the output.

In one embodiment, resistor 504 is a thermistor with a positive temperature coefficient in which resistance increases with temperature. If the output of the voltage divider consisting of resistors 502, 504 rises above the reference point at the inverting input of the op-amp 512, then the op-amp 512 turns on. In another embodiment, resistor 502 is a thermistor with a negative temperature coefficient in which resistance decreases with temperature. In other embodiments, other temperature sensors may be used or connected to the circuit in other locations. The present invention also supports external dimming by, for example, a triac or other forward or reverse wall dimmer. One or more of the embodiment discussed above may be used in practice either combined or separately including having and supporting both 0 to 10 V and triac and/or other wall dimming. The present invention can also have very high power factor. The present invention can also be used to support dimming of a number of circuits, drivers, etc. including in parallel configurations. For example, more than one driver can be put together, grouped together with the present invention.

The controller of FIG. 5 may be used in conjunction with dimming to provide thermal control or other types of control in a dimming LED driver. For example, the circuit of FIG. 5 or variations thereof may also be adapted to provide overvoltage or overcurrent protection, short circuit protection in a dimming LED driver, or to override and cut the power in the dimming LED driver based on any arbitrary external signal(s). The present invention can also include circuit breakers including solid state circuit breakers and other devices, circuits, systems, etc. That limit or trip in the event of an overload condition/situation. The present invention can be implemented in any part of the circuit including the secondary or primary of an isolated circuit or the high or low side of a non-isolated circuit. The present invention can be used with a buck, a buck-boost, a boost-buck and/or a boost, flyback, or forward-converter design, topology, implementation, etc.

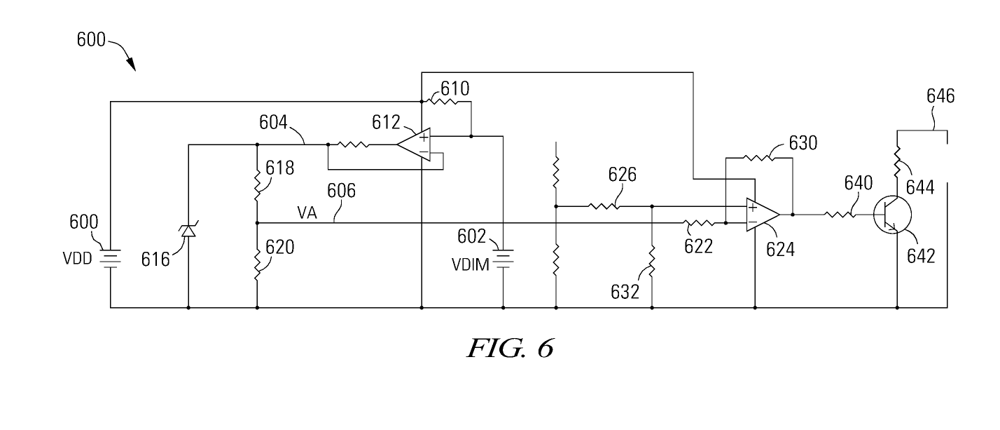

Another embodiment of a dimming controller 600 is illustrated in FIG. 6, in which a VDIM voltage supply 602 represents a voltage from a dimmer from, for example but not limited to, a 0-10 V Dimmer. When VDIM 602 is connected, VOUT 604 will track VDIM 602, and output VA 606 will be a divided version of VOUT. As in FIG. 2, if VDIM 602 is not connected, resistor 610 will pull the non-inverting input of op-amp 612 up to or close to VDD 614, op-amp 612 will supply current in an attempt to pull VOUT 604 up to the rail 614, and VOUT 604 will stay at the voltage limited by Zener diode 616, setting a maximum constant voltage level at output VA 606 to limit the load current. The output of the voltage divider consisting of resistors 618, 620 is then fed to resistor 622 which, in turn, is fed to the inverting input of, in this particular example, a difference operational amplifier consisting of op-amp 624 and resistors 622, 626, 630 and 632. The difference op amp can have unity or any other appropriate gain. Although not illustrated here, time constants can be inserted in implementations of the present invention including, but not limited to, for example, the figures discussed in this document. The present invention may include one or more time constants in any suitable location throughout the driver or distributed in multiple locations, and may be embodied in any suitable manner, not to be limited to, for example, RC time constants.

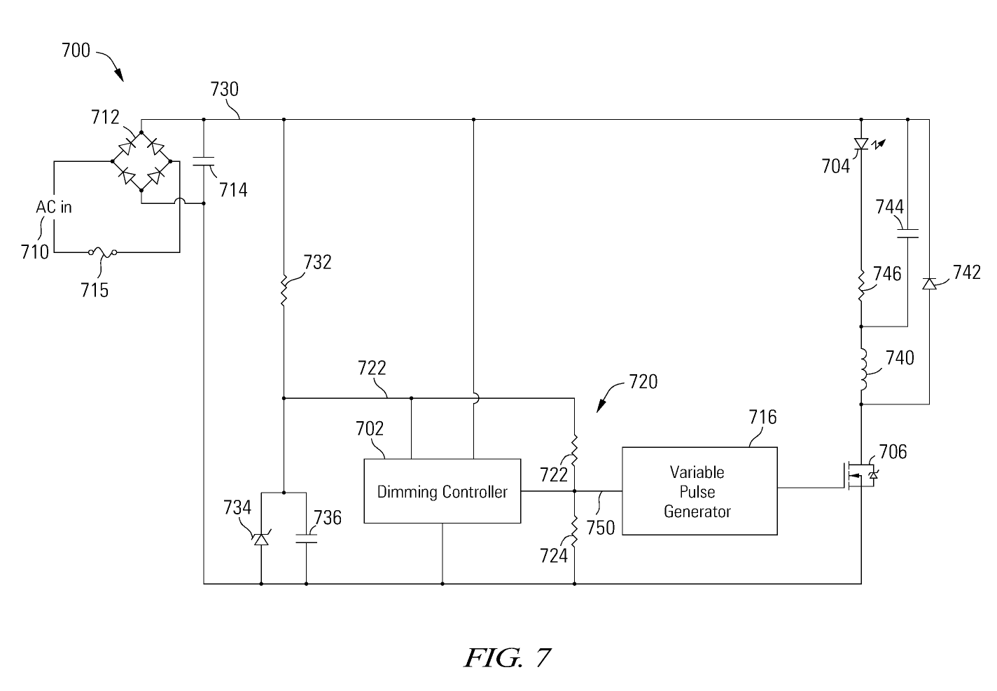

Resistor 640 feeds bipolar transistor 642 to connect resistor 644 at output 646 in parallel with a control resistor for a pulse generator circuit, such as the lower resistor 724 in voltage divider 720 of FIG. 7, which operates in conjunction with the upper voltage divider resistor 722 to control the pulse generator 704 to set the pulse width and/or frequency or other characteristics. Resistor 644 may be a smaller value than that resistor 724, so that when transistor 644 is turned on, it will reduce the voltage from the voltage divider (e.g., 120) and reduce the pulse width. Although a bipolar junction transistor is depicted, any appropriate device, switch, etc. can be used including MOSFETs, JFETs, other types of FETs, MODFETs, SiC FETs, GaN FETs, high electron mobility transistors (HEMTs), heterojunction bipolar transistors (HBTs), etc.

Turning to FIG. 7, a schematic depicts an example LED driver 700 with a dimming controller 702 such as, but not limited to, the dimming controller 600 of FIG. 6 in accordance with some embodiments of the invention. A dimmable constant current is supplied to the load 704, regulated by a switch such as a transistor 706, under the control of a variable pulse generator 716. The transistor 706 may be any suitable type of transistor or other device, such as a bipolar transistor or field effect transistor of any type and material including but not limited to metal oxide semiconductor FET (MOSFET), junction FET (JFET), bipolar junction transistor (BJT), heterojunction bipolar transistor (HBT), insulated gate bipolar transistor (IGBT), MODFETs, SiC FETs, GaN FETs, high electron mobility transistors (HEMTs), etc, and can be made of any suitable material including but not limited to silicon, silicon on insulator (SOI), silicon germanium (SiGe), gallium arsenide, gallium nitride, silicon carbide, diamond, combinations of these materials, based on these materials, etc which has a suitably high voltage rating. An AC input 710 is rectified in a rectifier 712 such as a diode bridge and may be conditioned using a capacitor 714. An electromagnetic interference (EMI) filter (not shown) may be connected to the AC input 710 to reduce interference, and a fuse 715 or similar device or devices may be used to protect the driver and wiring from excessive current due to short circuits or other fault conditions.

The variable pulse generator 716 generates pulses that turn the transistor 706 on and off, with the on-time of the pulses or pulse width controlled by, for example, a voltage divider 720 made up, for example, of resistors 722, 724, referenced to a bias supply 726.

The bias supply 726 may be used to power internal components as well, such as the variable pulse generator 716 and dimming controller 702. The bias supply 726 may be set at any suitable voltage/signal level relative to the DC input 730, and may be generated by any suitable device or circuit. For example, a resistor 732 in series with a Zener diode 734 and capacitor 736 may be used, optionally in combination with other components, to generate the bias supply 726 based on the DC input 730 or other voltage or current source.

An inductor 740 and the load 704 are connected in series with the switch 706, and a diode 742 is connected in parallel with the inductor 740 and the load 704. When the transistor 706 is turned on or closed, current flows from the rectified DC input 730 through the load 704 and energy is stored in the inductor 740. When the transistor 706 is turned off, energy stored in the inductor 740 is released through the load 704, with the diode 742 forming a return path for the current through the load 704 and inductor 740. The inductor 740, load 704 and diode 742 thus form a load loop in which current continues to flow briefly when the transistor 706 is off. In some embodiments, the load loop is placed above the switch 706, in other embodiments, the load loop is placed below the switch 706. Other optional components such as capacitors (e.g., 744) and resistors (e.g., 746) may be included in the driver for various purposes.

Again, the voltage divider 720 sets the pulse width from the variable pulse generator 716 as needed to produce the desired load current when the DC input 730 is at the expected normal voltage level. During various operating conditions, the dimming controller lowers the voltage at a control node 750 to reduce the pulse width from the variable pulse generator 716, such as under the control of a 0 to 10 V Dimming signal, or during overtemperature or overvoltage conditions. Accordingly, the dimming controller 702 may comprises any of the embodiments disclosed herein, such as, but not limited to, the dimming controller 600 of FIG. 6, or any variations of the embodiments disclosed herein.

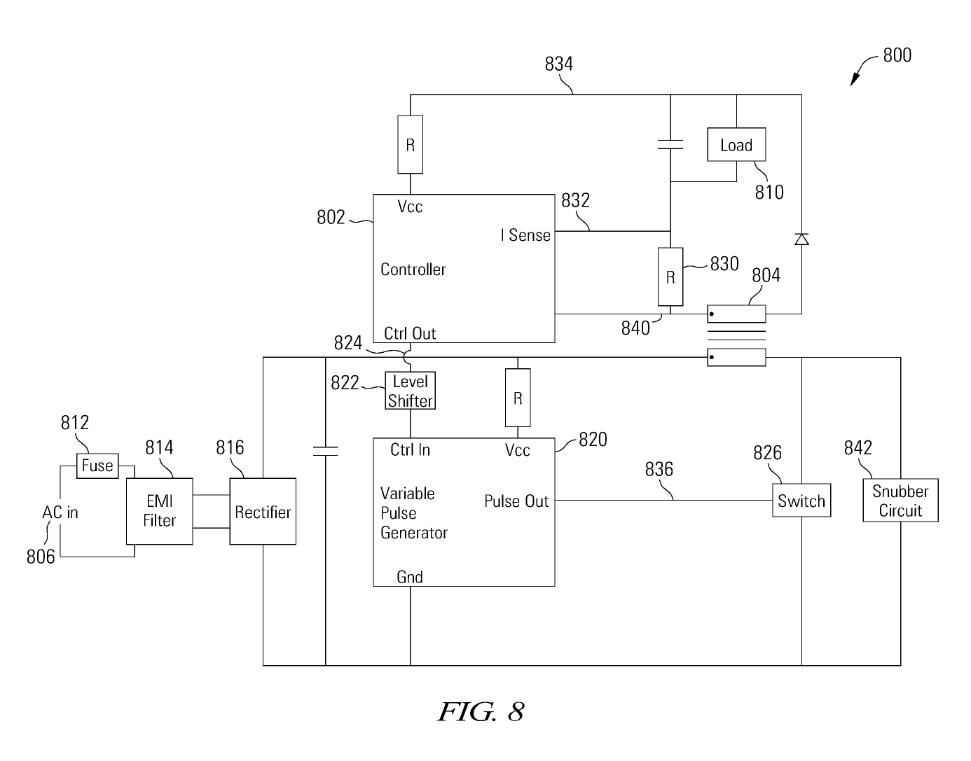

As another application of the example embodiments disclosed herein, a dimmable power supply 800 is disclosed in FIG. 8, where, for example, the dimmable LED controller 10 may be included to set the maximum load current using CurrentSP node 14 in place of controller 802. The dimmable power supply 800 may include a transformer 804 in the flyback mode of operation to provide isolation between the AC input 806 and the load 810. The AC input 806 is connected to the dimmable power supply 800 in this embodiment through a fuse 812 and an electromagnetic interference (EMI) filter 814. The fuse 812 may be any device suitable to protect the dimmable power supply 800 from overvoltage or overcurrent conditions. The AC input 806 is rectified in a rectifier 816. In other embodiments, the dimmable power supply 800 may use a DC input. The dimmable power supply 800 is generally divided into a high side portion including a controller 802 and a low side portion including a variable pulse generator 820. The high side portion is connected to one side of the transformer 804, such as the secondary winding, and the low side portion is connected to the other side of the transformer 804, such as the primary winding. A level shifter such as opto-isolator 822 is employed between the controller 802 in the high side and the variable pulse generator 820 in the low side to communicate the control signal 824 to the variable pulse generator 820. The load 810 is powered from the AC input 806 through the rectifier 816 and the transformer 804, with the current regulated by switch 826.

A current reference signal, corresponding in some embodiments with the CurrentSP node 14 of FIG. 1, is generated internally in some embodiments of the controller 802, for example using the 0 to 10 V Dimming input 12 of FIG. 1.

In the high side portion, as current flows through the load 810, the load current sense resistor 830 provides a load current feedback signal 832, corresponding in some embodiments with load current feedback signal 66 (FIG. 1), to the controller 802. The controller 802 compares the current reference signal (e.g., CurrentSP node 14) with the load current feedback signal 832 (e.g., load current feedback signal 66), and generates the control signal 824 to the variable pulse generator 820.

A time constant is applied in some embodiments to the load current feedback signal 832, or in any other suitable locations, to effectively average out and disregard current fluctuations due to any waveform at the power input 834 and pulses from the variable pulse generator 820 through the transformer 804.

The variable pulse generator 820 adjusts the pulse width of a train of pulses at the pulse output 836 of the variable pulse generator 820 based on the level shifted control signal 824 from the controller 802. The opto-isolator 822 shifts the control signal 824 from the controller 802 which is referenced to the local ground 840 by the controller 802, referencing it to a level appropriate to use by the variable pulse generator 820. Again, the level shifter may comprise any suitable device for shifting the voltage of the control signal 94 between isolated circuit sections, such as an opto-isolator, opto-coupler, resistor, transistor(s), transformer, etc. In other embodiments, the control signal 824 or ground nodes or other reference voltage nodes may be connected between the high side and low side of the dimmable power supply 800, tying them together and avoiding the need for a level shifter.

A snubber circuit 330 may be included, for example, with the switch 826 if desired to suppress transient voltages in the low side circuit. It is important to note that the dimmable power supply 800 is not limited to the flyback mode configuration illustrated in FIG. 8, and that a transformer-or inductor-based dimmable power supply 800 may be arranged in any desired topology including, for example, but not limited to a forward transformer configuration. The present invention is not limited to any particular topology or control scheme and can be generally applied to single and multiple stage topologies including but not limited to constant on time, constant off time, constant, frequency, variable frequency, variable duration, discontinuous, continuous, critical conduction modes of operation, CUK, SEPIC, boost-buck, buck-boost, buck, boost, forward, flyback, etc. and any combination of these and other circuit topologies.

Other embodiments can use comparators, other op amp configurations and circuits, including but not limited to error amplifiers, summing amplifiers, log amplifiers, integrating amplifiers, averaging amplifiers, differentiators and differentiating amplifiers, etc. and/or other digital and analog circuits, microcontrollers, microprocessors, complex logic devices, field programmable gate arrays, etc.

The present invention includes implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be included in an integrated circuit, be an integrated circuit, etc.

In some embodiments, in place of an external dimming source voltage VDIM, an external variable resister or potentiometer may be used to set the dimming level as well as any and all other standard methods and ways of interfacing to and with 0 to 10 V dimming. The present invention can be self-powered or acquire power from other sources, can, if needed, provide the power and voltage required for the 0 to 10 V dimming, can be designed and implemented to provide passive and/or active dimming, etc. The present invention can interface with resistors, potentiometers, voltage dividers, variable resistors, capacitive dividers, etc.

The present invention can be used on power supplies of essentially any type and form including switching power supplies and linear power supplies. Although not explicitly shown here, the same principles, concepts, operations, operating principles, designs, approaches, methods, etc. apply to linear circuits and power supplies, drivers, etc. in which a voltage and/or power or multiple voltages and/or power and/or current monitor and/or signals are fed/connected/inserted at appropriate point(s) in the respective switching and/or linear or combinations of these power supplies, drivers, ballasts, etc to control, limit and/or turn off the output current (or voltage or power) of the respective power supplies, drivers, ballasts, etc.

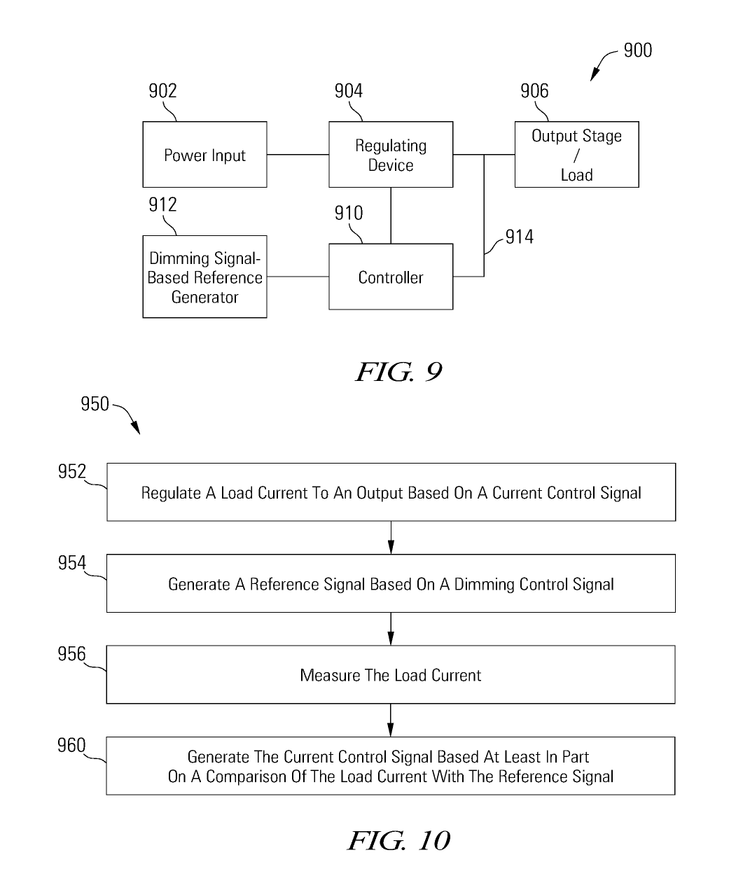

In general, as disclosed in FIG. 9, a dimmable LED driver 900 comprises a power input 902, a regulating device 904, an output stage and load or load output 906, and a controller 910 that controls the regulating device 904 based on a load current feedback signal 914 and a reference signal from a dimming signal-based reference generator 912. The term “regulating device” is thus used herein to refer to the element of the power supply that regulates the output current, such as a switch and pulse generator in a switching power supply, or a Zener diode and series resistor in one type of linear power supply, or error amplifier and transistor in another type of linear power supply, etc.

For example, in some embodiments, the regulating device 904 comprises a switch (e.g., 826), the controller 910 comprises both a variable pulse generator (e.g., 820) and a current level setting circuit (e.g., 802) based on a current feedback signal 914 (e.g., 832) and a dimming signal reference generator 912 that generates a reference signal against which the current feedback signal 914 is compared in controller 910, based at least in part on a dimming signal such as, but not limited to, a 0 to 10 V Dimming signal as disclosed in FIGS. 1-6 or in variations thereof. Some embodiments of the dimmable LED driver 900 also include thermal control, overvoltage control, etc as disclosed herein.

In another example, in some embodiments the dimmable LED driver 900 comprises a linear power supply, in which the controller 910 can be used to turn off the regulating device 904, such as, but not limited to, a series or parallel regulating device acting as a variable resistor, based on a comparison of the current feedback signal 914 and the reference signal generated by the dimming signal reference generator 912.

The present invention can also be applied to linear regulator power supplies and sources including linear LED drivers. Some embodiments of the present invention as applied to linear power supplies and drivers, etc., can use the dimming signal to set/control the output current or voltage of the linear power supply, driver, etc.

Turning to FIG. 10, a flow diagram 950 depicts an operation for regulating a current to a load such as an LED, another type of light, or other type of load is disclosed in accordance with some embodiments of the present invention. Following flow diagram 950, a load current (or voltage) to an output is regulated based on a control signal. (Block 952) A reference signal is generated based on a dimming control signal. (Block 954) The load current (or voltage) is measured. (Block 956) The control signal is generated based at least in part on a comparison of the load current with the reference signal. (Block 956)

Implementations of the present invention, whether applied to switching or linear or combinations/combined linear/switching power supplies, drivers, ballasts, etc. may be based on one or more of the above control/monitoring signals including, for example, a signal based on the input voltage or a scaled version/representation of the input voltage with other embodiments and implementations of the present invention also using other/additional current limiting information and signals, etc. as well as other methods, approaches, signals, monitoring and control information mentioned elsewhere in this document.

The present invention includes implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc.

The example embodiments disclosed herein illustrate certain features of the present invention and not limiting in any way, form or function of present invention. The present invention is, likewise, not limited in materials choices including semiconductor materials such as, but not limited to, silicon (Si), silicon carbide (SiC), silicon on insulator (SOI), other silicon combination and alloys such as silicon germanium (SiGe), etc., diamond, graphene, gallium nitride (GaN) and GaN-based materials, gallium arsenide (GaAs) and GaAs-based materials, etc. The present invention can include any type of switching elements including, but not limited to, field effect transistors (FETs)such as metal oxide semiconductor field effect transistors (MOSFETs) including either p-channel or n-channel MOSFETs, junction field effect transistors (JFETs), metal emitter semiconductor field effect transistors, etc. again, either p-channel or n-channel or both, bipolar junction transistors (BJTs), heterojunction bipolar transistors (HBTs), high electron mobility transistors (HEMTs), unijunction transistors, modulation doped field effect transistors (MODFETs), etc., again, in general, re-channel or p-channel or both, vacuum tubes including diodes, triodes, tetrodes, pentodes, etc. and any other type of switch, etc. The current limiter can used with LED drivers designed for continuous conduction mode (CCM), critical conduction mode (CRM), discontinuous conduction mode (DCM), resonant conduction modes, etc., with any type of circuit topology including but not limited to buck, boost, buck-boost, boost-buck, Cuk, SEPIC, flyback, forward-converters, etc. The present invention works with both isolated and non-isolated designs.

While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims. The example embodiments are in no way meant or intended to be limiting with the present invention having general and universal applicability well beyond the example embodiments shown herein.

What is claimed is:

1. A power supply comprising:
a power input;
a load output;
a current regulating device;
a controller operable to adjust the current regulating device to control a current level at the load output; and
a dimming controller operable to process a dimming control signal to provide a reference signal to the controller.

2. The power supply of claim 1, wherein the current regulating device comprises a linear regulator.

3. The power supply of claim 1, wherein the current regulating device comprises:
a power control switch operable to control a flow of current from the power input to the load output; and
a pulse generator comprising a pulse output connected to the power control switch and a control input operable to control the pulse output.

4. The power supply of claim 3, further comprising a voltage divider connected to the control input, wherein the dimming controller is connected to the voltage divider.

5. The power supply of claim 3, wherein the pulse generator comprises a variable pulse generator, wherein the pulse output comprises a duty cycle controlled by a signal at the control input.

6. The power supply of claim 1, wherein the controller comprises a current limiter operable to cause the current regulating device to limit the flow of current from the power input to the load output during overvoltage conditions at the power input.

7. The power supply of claim 6, wherein the dimming controller provides the reference signal to the current limiter.

8. The power supply of claim 1, the dimming controller comprising an output resistor connected in series with a switch.

9. The power supply of claim 1, the dimming controller comprising a voltage source and a dimming control signal input operable to pull down a dimming input from the voltage source at a first node.

10. The power supply of claim 9, wherein the dimming control signal comprises a 0 to 10 volt dimming control signal.

11. The power supply of claim 10, the dimming controller further comprising a buffer operable to yield a buffered dimming signal at a second node.

12. The power supply of claim 11, the dimming controller further comprising a Zener diode connected to the second node and operable to limit a voltage at the second node.

13. The power supply of claim 1, further comprising a thermal controller operable to cause the controller to limit the current level at the load output when a temperature increases.

14. A method of controlling an electrical current, comprising:
regulating a load current to an output based on a control signal;
generating a reference signal based on a dimming control signal;
measuring the load current; and
generating the control signal based at least in part on a comparison of the load current with the reference signal.

15. The method of claim 14, wherein regulating the load current comprises generating a pulse stream to control a switch, wherein current flows from a power input to the output when the switch is closed, and wherein current flows from an energy storage device to the load output when the switch is open.

16. The method of claim 14, wherein generating the reference signal comprises reducing an input voltage with the dimming control signal to yield a dimming input.

17. The method of claim 16, wherein generating the reference signal further comprises buffering the dimming input to yield a dimming output.

18. The method of claim 17, wherein generating the reference signal further comprises capping a voltage of the dimming output to yield a limited dimming output.

19. The method of claim 18, wherein the dimming output is voltage controlled.

20. A current limiting driver circuit, comprising:
a power input;
a load output connected to the power input;
an inductor connected in series with the load output;
a diode connected in parallel with the load output and the inductor;
a switch connected in series with the load output and the inductor, wherein when the switch is open, current flows from the power input to the load output, and wherein the switch is closed, current flows from the inductor to the load output;
a pulse generator connected to a control input of the switch;
a current controller connected to the pulse generator operable to control a current to the load output by adjusting a pulse width at the control input of the switch; and
a dimming controller operable to process a dimming control signal to provide a reference signal to the current controller.
